(19) United States
(12) Patent Application Publication
(10) Pub. No.: US 2018/0236651 A1
(43) Pub. Date: Aug. 23, 2018

(54) SAW HORSE SYSTEM AND METHOD

(71) Applicant: MATTHEW BRANDON BERGSMA, SOUTH SURREY (CA)

(72) Inventor: MATTHEW BRANDON BERGSMA, SOUTH SURREY (CA)

(21) Appl. No.: 15/438,672

(22) Filed: Feb. 21, 2017

(51) Int. Cl. B25H 1/06

(52) U.S. Cl. CPC B25H 1/06

(57) ABSTRACT

A saw horse system having an aluminum collapsible folding frame having four legs affixed to a centrally hinged work surface configured to have an opening extending linearly between hinged sections including a bracket having a L-shape cross section which is pivotally affixed to each respective hinged section and below the centrally hinged work surface. The opening between the hinged sections is configured to support a replaceable-sacrificial-member affixed to each L bracket via the predrilled through-holes to prevent unintended damage to the collapsible folding frame.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of saw accessories and more specifically relates to a saw horse system.

### 2. DESCRIPTION OF RELATED ART

A sawhorse is a beam with four legs used to support a board or plank for sawing. A pair of sawhorses can support a plank, forming a scaffold. A sawhorse can also be used as the base for a portable work table by placing a sheet of plywood or even a door on top of two sawhorses. If the sawhorses are strong enough, the portable table can be used as a platform for tools like a table saw, although with caution if the top is not secured to the sawhorses.

A sawhorse may be designed to fold for storage. A sawhorse with a wide top is particularly useful to support a board for sawing or as a field workbench, but also more difficult to store. When cutting a material on a saw horse using a power saw it is common to have a portion of the cutting blade extending beyond the thickness of the material being cut, this is what is known as the blind-side of a cut. Many times when cutting with a power saw the worker may accidentally cut into the saw horse with the blind-side of the saw blade causing permanent damage to the saw horse. This is both undesirable and expensive.

U.S. Pat. No. 3,696,887 to Jerome J. Brzkcy relates to a combination sawhorse, scaffold support and table. The described saw horse includes a combination saw horse, scaffold and table including a false removable top element for the upper beam of the saw horse, horizontal braces for the leg elements provided with inverted channel cappings as a metal scaffold support means, and a demountable table top for the top beam.

### BRIEF SUMMARY OF THE INVENTION

In view of the foregoing disadvantages inherent in the known saw horse art, the present disclosure provides a novel sawhorse system. The general purpose of the present disclosure, which will be described subsequently in greater detail, is to provide a sawhorse system for efficient project use. The saw horse system disclosed herein comprises: an aluminum collapsible folding frame having four legs affixed to a centrally hinged work surface configured to have an opening extending linearly between hinged sections that may include at least one bracket having a L-shape cross section which is pivotally affixed to the hinged section at each end and below the centrally hinged work surface facing inwardly including a plurality of predrilled through-holes.

In the preferred embodiment the opening between the hinged sections is may be configured to support a replaceable-sacrificial-member removably affixed to each bracket having the L shape cross section via the predrilled through-holes to prevent unintended damage to the collapsible folding frame.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a saw horse system, constructed and operative according to the teachings of the present disclosure.

FIG. 1 is a side view of the saw horse system during an ‘in-use’ condition, according to an embodiment of the disclosure.

FIG. 2 is a top view of the saw horse system of FIG. 1, according to an embodiment of the present disclosure.

FIG. 3 is a front view of the saw horse system of FIG. 1, according to an embodiment of the present disclosure.

FIG. 4a is a folding view of the saw horse system of FIG. 1, according to an embodiment of the present disclosure.

FIG. 4b is a folding view of the saw horse system of FIG. 1, according to an embodiment of the present disclosure.

FIG. 5 is a flow diagram illustrating a method of use for a saw horse system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a saw horse and more particularly to a saw horse system as used to improve the saw horse by providing a replaceable-sacrificial-member. Generally, the problem with use of conventional aluminum saw horse is that when cutting material over aluminum, there is a blind spot that often results in cutting through the material and into the aluminum, rendering the saw horse useless. The solution to this problem is to create a sawhorse with an added lumber substrate on top of the aluminum mitigating the problem of cutting into the aluminum.

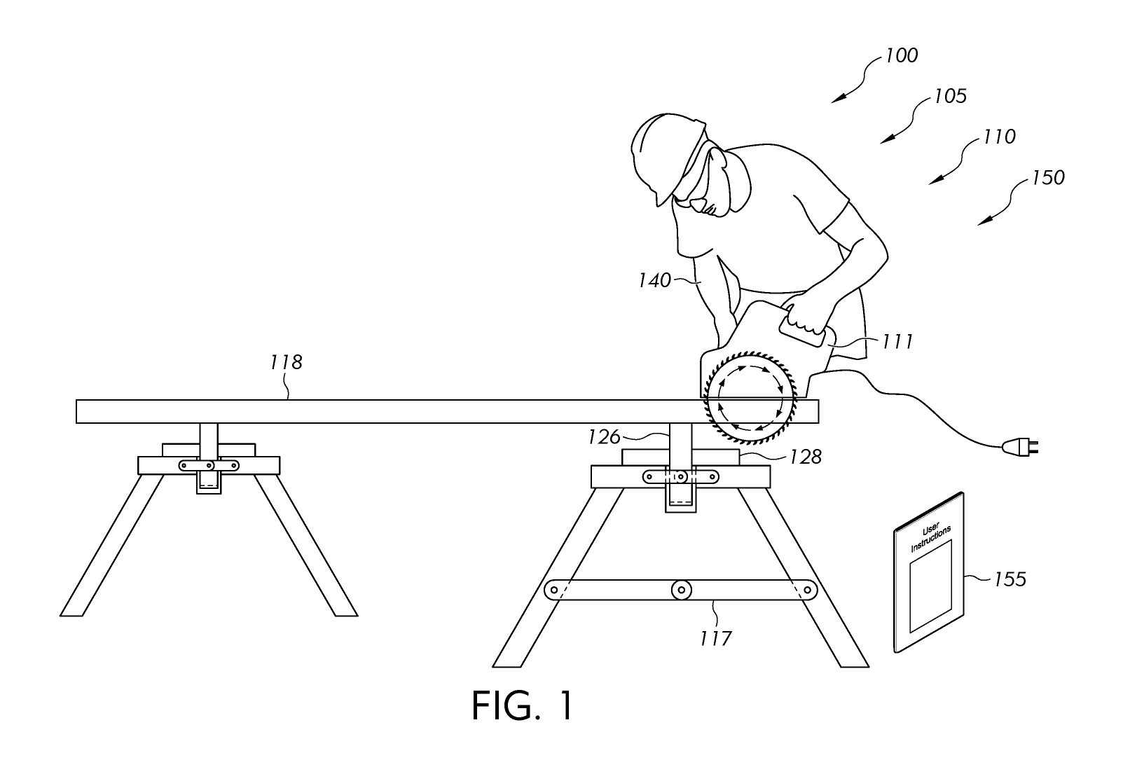

Referring now more specifically to the drawings by numerals of reference, there is shown in FIGS. 1-4b, various views of a saw horse system 100. FIG. 1 shows a saw horse system 100 during an ‘in-use’ condition 150, according to an embodiment of the present disclosure. Here, the saw horse system 100 may be beneficial for use by a user 140 to support a replaceable-sacrificial-member 126, when cutting work material with a power saw without damaging the saw horse. As illustrated, the saw horse system 100 may include an aluminum collapsible folding frame 110, having four legs 112, affixed to a centrally hinged work surface 120, configured to have an opening extending linearly 130, between hinged sections 124. The opening between the hinged sections 124, is configured to support a replaceable-sacrificial-member 126, affixed to at least one bracket having the L-shape cross section 122, via the predrilled through-holes 132, to prevent unintended damage to the collapsible folding frame 110, and alternately providing a mount for scaffolding 118.

According to one embodiment, the saw horse system 100 may be arranged as a kit 105. In particular, the saw horse system 100 may further include a set of instructions 155. The instructions 155 may detail functional relationships in relation to the structure of the saw horse system 100 (such that the saw horse system 100 can be used, maintained, or the like, in a preferred manner).

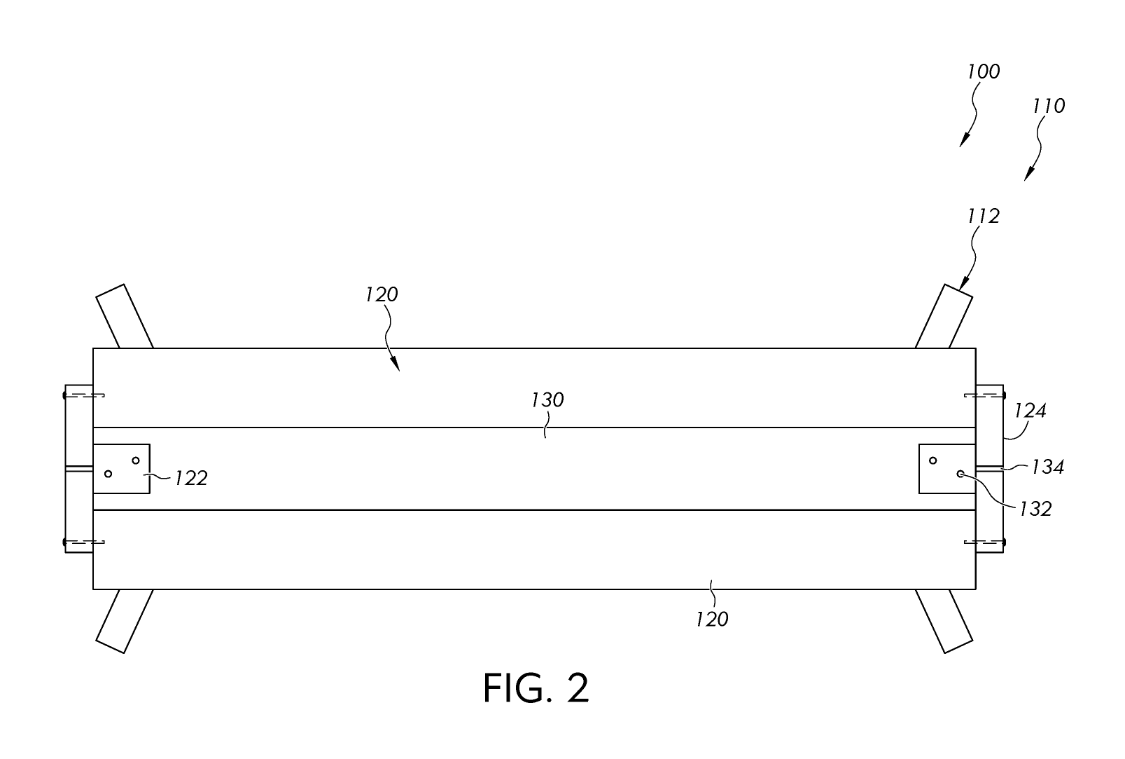

FIG. 2 is a top view of the saw horse system 100 of FIG. 1, according to an embodiment of the present disclosure. As above, the saw horse system 100 may include at least one bracket having an L-shape cross section 122, which is pivotally affixed to each respective said hinged section 124, and below the centrally hinged work surface 120, facing inwardly including a plurality of predrilled through-holes 132. The opening extends linearly 130 between the hinged sections 124, and is configured to support a replaceable-sacrificial-member 122, affixed to each said bracket having the L shape cross section 124, via the predrilled through-holes 132, as shown in FIG. 2 to prevent unintended damage to the collapsible folding frame 110.

The centrally hinged work surface 120, may have preferred dimensions of about 34 inches high by 30½ inches long by 9⅝ inches wide and a base foot print measuring 33 inches wide by 34 inches in length when in in use condition 150. Additionally the centrally hinged work surface 120, may be configured having an opening extending linearly 130, measuring 1¾ inches wide by 29 inches long and may further include at least one bracket having the L-shape cross section 124, measuring 1¾ inches by 1¾ inches that may be pivotally affixed to each respective hinge by a 3/16 inch by ¼ inch bolt and nut fastener 134. FIG. 2 furthers shows four legs 112, that may be each fixedly fastened to the centrally hinged work surface 120, at each corner. It should be appreciated that other dimensions may be used for the various components of the present invention.

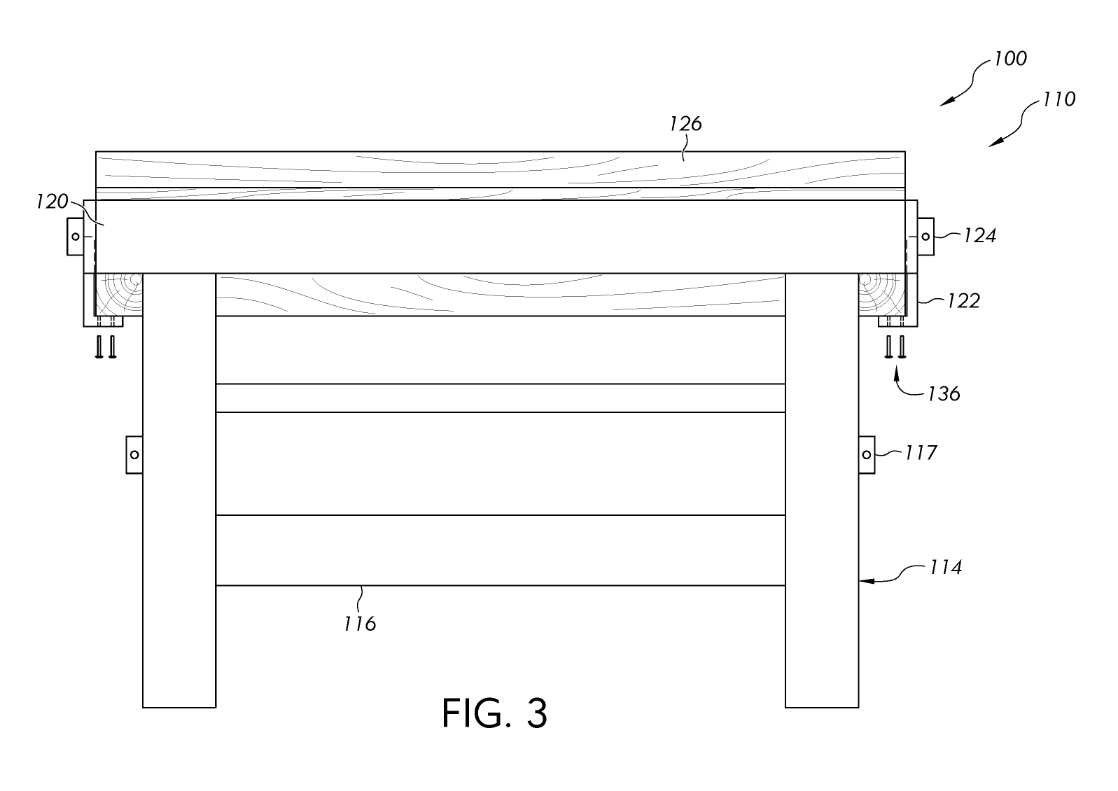

FIG. 3 is a front view of the saw horse system 100 of FIG. 1, according to an embodiment of the present disclosure. The four legs 112, comprise two pair of legs 114, including at least one horizontal cross brace 116, fixed lengthwise at a mid section and a replaceable-sacrificial-member 126, that may comprise a wood or composite material such that centrally hinged work surface 129, is protected from cut-damage from a circular saw or the like in use. The replaceable-sacrificial-member 126 may be removabley affixed to the brackets having the L-shape cross section 122, with screw-fasteners 136. The replaceable-sacrificial-member 126, may be configured having a T-shape cross section 128, (FIG. 1) such that it extends 1¾ inches below a top surface of the centrally hinged work surface 120, within the opening extending linearly 130, and secured to the bracket having the L-shape cross section 122, with screw-fasteners 136, such that it is stabilized during use.

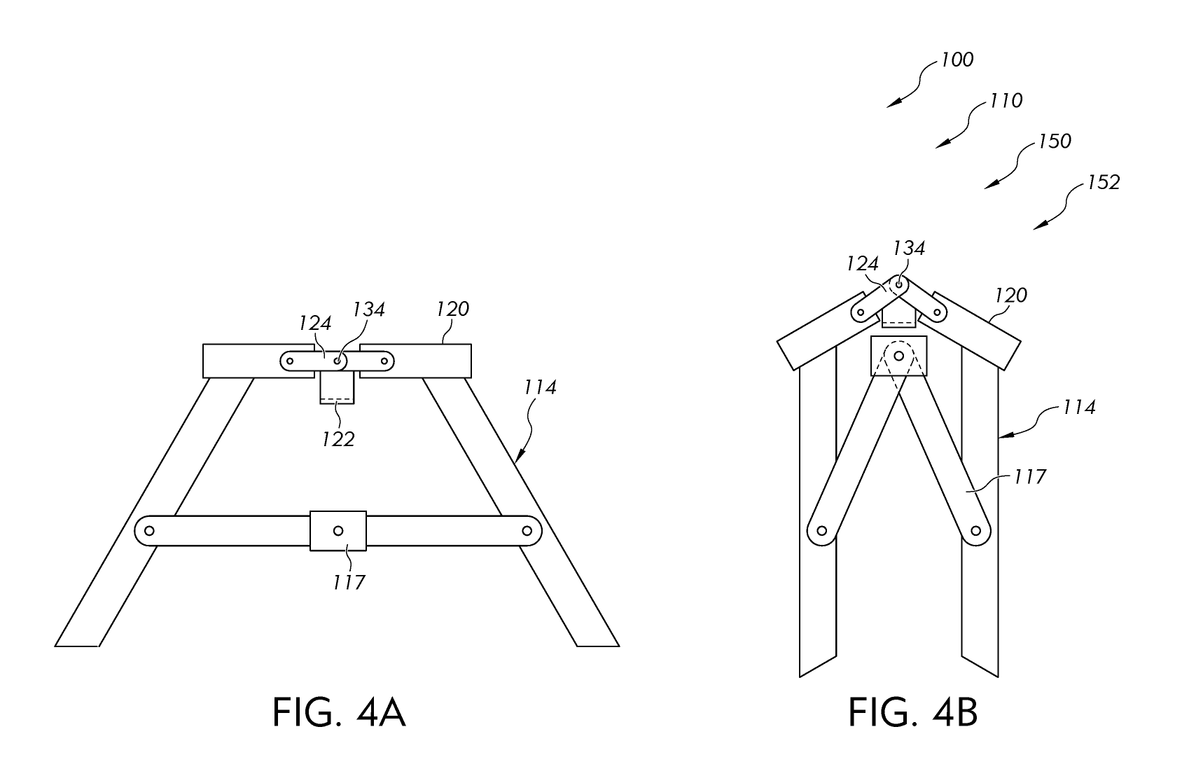

FIGS. 4a and 4b show end views of the saw horse system 100 of FIG. 1, according to an embodiment of the present disclosure. As shown each of the pair of legs 114, further include a horizontal locking expansion brace 117, pivotally hinged and affixed widthwise at the mid section. The aluminum collapsible folding frame 110 is hinged such that it is able to move between an in-use condition 150, and a folded condition 152, and back.

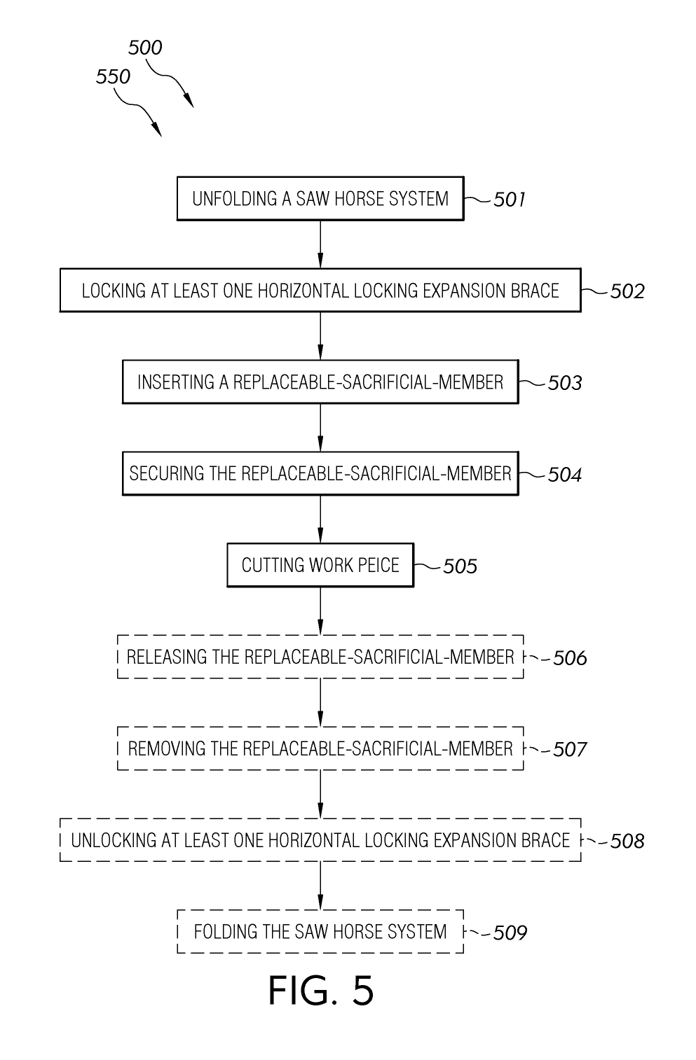

FIG. 5 is a flow diagram illustrating a method of use 500 for the saw horse system 100, according to an embodiment of the present disclosure. In particular, the method of use 500 for the saw horse system use 100 may include one or more components or features of the saw horse system 100 as described above. As illustrated, the method 500 for the saw horse system 100 may include the steps of: step one 501, unfolding a saw horse system 100, step two 502, locking the at least one horizontal locking expansion brace, step three 503, inserting a replaceable-sacrificial-member, step four 504, securing the replaceable-sacrificial-member, step five 505, cutting a work piece, step six 506, releasing the replaceable-sacrificial-member, step seven 507, removing the replaceable-sacrificial-member, step eight 508, unlocking at least one horizontal locking expansion brace, step nine 509, folding the saw horse system.

It should be noted that steps 505-509 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for saw horse system (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A saw horse system comprising:
an aluminum collapsible folding frame having four legs affixed to a centrally hinged work surface configured to have an opening extending linearly between hinged sections;
a bracket having a L-shape cross section which is pivotally affixed to each respective said hinged section and below the centrally hinged work surface facing inwardly including a plurality of predrilled through-holes; and
wherein the opening between the hinged sections is configured to support a replaceable-sacrificial-member affixed to each said bracket having the L-shape cross section via the predrilled through-holes to prevent unintended damage to the collapsible folding frame.

2. The saw horse system of claim 1, wherein the centrally hinged work surface has dimensions of exactly 34 inches high by 30½ inches long by 9⅝ inches wide.

3. The saw horse system of claim 1, wherein a base foot print measures exactly 33 inches wide by 34 inches in length when in use.

4. The saw horse system of claim 1, wherein the centrally hinged work surface has said opening extending linearly measuring exactly 1¾ inches wide by 29 inches long.

5. The saw horse system of claim 1, wherein the bracket having the L-shape cross section measures exactly 1¾ inches by 1¾ inches.

6. The saw horse system of claim 1, wherein the bracket having the L-shape cross section is pivotally affixed to each respective hinge by a 3/16 inch by ¼ inch bolt and nut fastener.

7. The saw horse system of claim 1, wherein the four legs are each fixedly fastened to the centrally hinged work surface at each corner.

8. The saw horse system of claim 1, wherein the four legs comprise two pair of said legs including at least one horizontal cross brace fixed lengthwise at a mid section.

9. The saw horse system of claim 8, wherein each of the pair of said legs further include a horizontal locking expansion brace pivotally hinged and affixed widthwise at the mid section.

10. The saw horse system of claim 1, wherein the replaceable-sacrificial-member comprises wood such that said centrally hinged work surface is protected from cut-damage from a saw in use.

11. The saw horse system of claim 1, wherein the replaceable-sacrificial-member is made of composite material.

12. The saw horse system of claim 1, wherein the replaceable-sacrificial-member is removable affixed to each of the brackets having said L-shape cross section with screw-fasteners.

13. The saw horse system of claim 10, wherein the replaceable-sacrificial-member is configured having a T-shape cross section.

14. The saw horse system of claim 1, wherein the replaceable-sacrificial-member extends 1¾ inches below a top surface of the centrally hinged work surface within the opening extending linearly.

15. The saw horse system of claim 1, wherein the replaceable-sacrificial-member forms scaffolding for use.

16. The saw horse system of claim 1, wherein the aluminum collapsible folding frame is hinged such that said aluminum collapsible folding frame is able to move between an in-use condition and a folded condition and back.

17. A saw horse system comprising:
an aluminum collapsible folding frame having four legs affixed to a centrally hinged work surface configured to have an opening extending linearly between hinged sections;
a bracket having a L-shape cross section which is pivotally affixed to each respective said hinged section and below the centrally hinged work surface facing inwardly including a plurality of predrilled through-holes;
wherein the centrally hinged work surface has dimensions of exactly 34 inches high by 30½ inches long by 9⅝ inches wide;
wherein a base foot print measures exactly 33 inches wide by 34 inches in length when in use;
wherein the centrally hinged work surface has said opening extending linearly measuring exactly 1¾ inches wide by 29 inches long;
wherein the bracket having the L-shape cross section measures exactly 1¾ inches by 1¾ inches;
wherein the bracket having the L-shape cross section is pivotally affixed to each respective hinge by a 3/16 inch by ¼ inch bolt and nut fastener;
wherein the four legs are each fixedly fastened to the centrally hinged work surface at each corner;
wherein the four legs comprise two pair of said legs including at least one horizontal cross brace fixed lengthwise at a mid section;
wherein each of the pair of said legs further include a horizontal locking expansion brace pivotally hinged and affixed widthwise at the mid section;
wherein the replaceable-sacrificial-member comprises wood such that said centrally hinged work surface is protected from cut-damage from a saw in use;
wherein the replaceable-sacrificial-member is removable affixed to each of the brackets having said L-shape cross section with screw-fasteners;
wherein the replaceable-sacrificial-member is configured having a T-shape cross section;
wherein the replaceable-sacrificial-member extends 1¾ inches below a top surface of the centrally hinged work surface within the opening extending linearly such that it is stabilized during use;
wherein the aluminum collapsible folding frame is hinged such that said aluminum collapsible folding frame is able to move between an in-use condition and a folded condition and back; and
wherein the opening between the hinged sections is configured to support a replaceable-sacrificial-member affixed to each said bracket having the L-shape cross section via the predrilled through-holes to prevent unintended damage to the collapsible folding frame and alternately providing a mount for scaffolding.

18. The saw horse system of claim 17, further comprising set of instructions; and
wherein the saw horse system is arranged as a kit with said replaceable-sacrificial-member and said aluminum collapsible folding frame.

19. A method of use for a saw horse system, the method comprising the steps of:
unfolding a saw horse system;
locking at least one horizontal locking expansion brace;
inserting a replaceable-sacrificial-member;
securing the replaceable-sacrificial-member;
cutting at least one work piece;
releasing the replaceable-sacrificial-member;
removing the replaceable-sacrificial-member;
unlocking at least one horizontal locking expansion brace; and
folding the saw horse system.
